(19) United States
(12) Patent Application Publication
(10) Pub. No.: US 2010/0313135 A1
(43) Pub. Date: Dec. 9, 2010

(54) Virtual Disc Enabled Media Player

(76) Inventors: Mark Rogers Johnson, Glendale, CA (US); Zane Vella, San Francisco, CA (US); Joseph Rice, Oakland, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/794,450

(22) Filed: Jun. 4, 2010

Related U.S. Application Data
(60) Provisional application No. 61/184,755, filed on Jun. 5, 2009.
(60) Provisional application No. 61/288,046, filed on Dec. 18, 2009.

(51) Int. Cl. G06F 15/16; G06F 3/048

(52) U.S. Cl. 715/738; 709/217

(57) ABSTRACT

A virtual disc enabled media player is disclosed. The media player includes a storage medium having instructions stored thereon which when executed by a processor in the media player cause certain actions to be performed. The actions include the media player executing a virtual disc software image as if it were a physical medium. This allows the player to access content and information when no physical media is present in the media player. The content and information may be obtained over a network such as the Internet. The media player may be a BLU-RAY DISC player.

### RELATED APPLICATION INFORMATION

This patent claims priority from U.S. provisional patent application 61/184,755 filed Jun. 5, 2009 and U.S. provisional patent application 61/288,046 filed Dec. 18, 2009, the contents of which are incorporated by reference herein in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a virtual media system that complies with a physical disc player standard, such as the Blu-ray Disc® specification.

2. Description of the Related Art

The Blu-ray Disc® (BD) specification describes requirements for discs and players that deliver improved video and sound when compared to predecessor compact disc (CD) and digital versatile disc (DVD) players. Traditionally, movies and other media available on tape and disc were fixed or static; that is they did not change. Although some tapes and discs included extra features and additional information related to the content of the tape or disc, there was not way to add more or newer extra features and information related to the content of the tape or disc. An improvement of Blu-ray Disc® players over earlier tape and disc players is that BD players may be network capable and may connect to the Internet. Such players are called BD-Live players. BD-Live allows features and information beyond what came on a BD disc to be accessed to augment and enhance the user's entertainment experience.

### DESCRIPTION OF THE DRAWINGS

FIG. 1 is a block diagram of an environment in which the virtual disc system described herein may be implemented.

FIG. 2 is a flow diagram of actions taken when a player that includes the virtual disc system described herein starts.

FIG. 3 is a flow diagram of actions taken when a player that includes the virtual disc system described herein plays or executes the virtual disc system.

FIG. 4 is a first flow diagram of actions taken when a player that includes the virtual disc system described herein plays a physical disc.

FIG. 5 is a second flow diagram of actions taken when a player that includes the virtual disc system described herein plays a physical disc.

FIG. 6 is a flow diagram of actions taken in a virtual disc system enabled media player.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

A virtual disc system (“VDS”) is described herein. The VDS enables deployment of value-added and, optionally, audience-targeted, applications, in media players such as Blu-ray Disc® players and devices that include media players such as Blu-ray Disc® players. The VDS may be used to facilitate the distribution of compelling related networked content and available network enhancements for physical media included in media players, such as a BD-ROM included in a Blu-ray Disc® player or a game cartridge in a video game console.

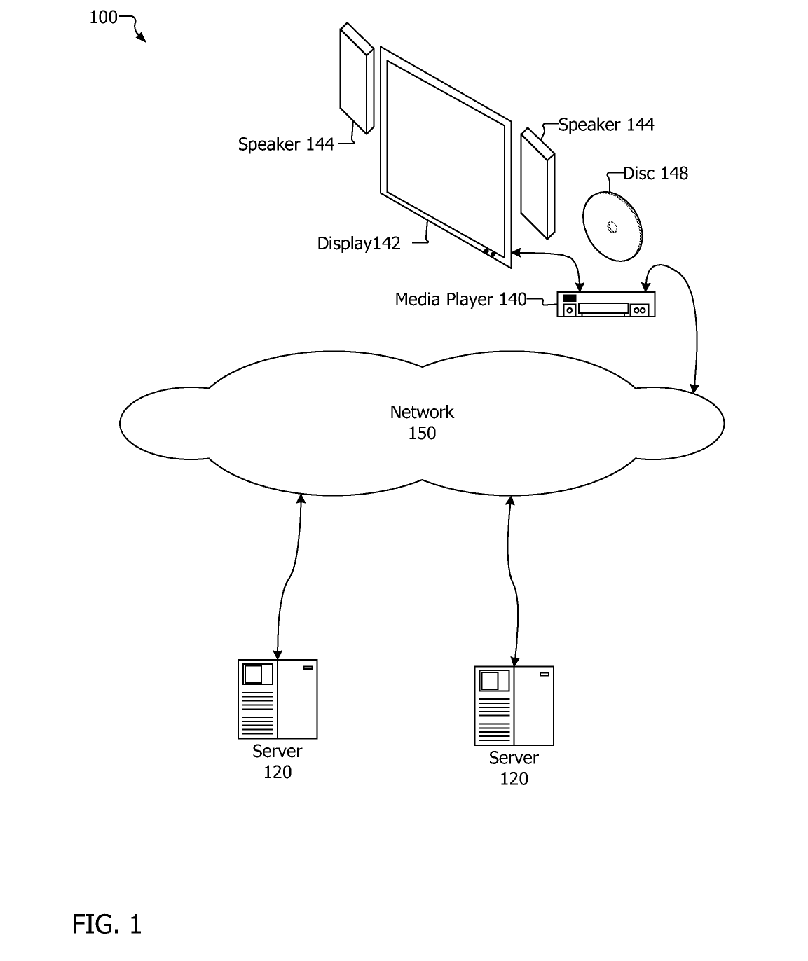

Referring now to FIG. 1, there is shown a block diagram of an environment in which the VDS may be implemented. The systems and methods described herein may be implemented in an environment 100 that includes the components shown in FIG. 1, namely a disc playback device, such as BD-ROM playback device shown as media player 140, a disc 148 or other portable medium, and servers 120. Although only two servers 120 are shown, there may be additional servers 120.

As used herein, BD refers to Blu-ray Disc®, and BD specification refers to the various documents that define the behavior and requirements of BD players, software and related systems, and, in particular, “System Description Blu-ray Disc Read-Only Format: Part 3. Audio Visual Basic Specifications”. The BD specification includes a section pertaining to virtual file system (“VFS”) updates.

The terms player, BD player, disc player and media player as used herein refer to a device that plays Blu-ray Discs®, namely BD players. BD players may also have the ability to write BD discs. The terms player, BD player, disc player and media player also include set-top boxes, personal video recorders, video game consoles, personal computers, and other devices that include Blu-ray Disc® players or have Blu-ray Disc® players coupled thereto.

The media player 140 supports the VFS feature set and has the ability to download files from a network server. The media player may be coupled with a display 142 and a network 150. The display may have speakers 144 included therein or coupled thereto. In another embodiment, the media player 140 may be coupled with an audio component such as a surround sound system, not shown, to which the speakers 144 may be coupled. Although only two speakers are shown, the system may have more speakers. Similarly, although only one display is shown, some embodiments may have multiple displays. Display 142 may be a high definition video monitor that conforms to a well-known standard, such as, for example, 1080 p. The display may be one of a variety of available technologies, including, for example, LCD, plasma, and projection.

The media player and/or a computing device to which it is coupled or included may be augmented with user input devices such as a keyboard, keypad, touch screen, buttons, mouse, track ball, pen and tablet, a hand-held motion detecting device, and others. The media player and/or a computing device to which it is coupled or included includes a network interface card or network interface chip or chipset and related software that allows for communication over the network 150. Other components may be included in or coupled with the media player.

The disc 148 may be a BD-ROM disc or other disc that may be read or played by the player 140. The disc 148 contains a fixed set of audio visual content and applications designed to operate within media player 140. Although shown as disc 148, the systems and methods described herein may be applicable to other portable media that have fixed content stored thereon, such as, for example, storage cartridges that include memory; memory or media cartridges, cards or sticks; flash memory devices; and other portable media that may be inserted into media players to be viewed on a display and heard from speakers or otherwise executed by a player.

The network 150 may be the Internet. The network 150 may be a local area network (LAN), a wide area network (WAN), a storage area network (SAN), or a combination of these. The network 150 may be wired, wireless, or a combination of these. The network 150 may be comprised of numerous nodes providing numerous physical and logical paths for data units to travel. Each node may be a computing device as described below. Communications on the network 150 may take various forms, including frames, cells, datagrams, packets, messages, streams, higher level logical groupings, or other units of information.

The servers 120 may store multiple sets of files containing content that may be used to provide content to a viewer/user when no disc is included in the media player 140 or to extend the static content included on the disc 148. As used herein, the term content refers to computer readable files including, but is not limited to, graphics files, video files, multimedia files, audio files, font files, HTML files, software applets or applications, software application updates, and others that may include previews/trailers, special features, advertisements, and may other kinds of content.

The server 120 may include a VDS server application that responds to a VDS client application included on a player. The VDS client application may communicate with the server 120 to download content files and information from one or more servers 120. The downloaded content and information files may be stored on local storage media included in or coupled with the media player 140. The VDS may play or otherwise make available the content to viewers/users when no disc is in the media player.

The media player 140, cable box, set top box, video game console, etc. and servers 120 are all considered computing devices. A computing device may include software and/or hardware for providing all or part of the functionality and features described herein. A computing device may include one or more of logic arrays, memories, analog circuits, digital circuits, software, firmware, and processors such as microprocessors, field programmable gate arrays (FPGAs), application specific integrated circuits (ASICs), read-only memory (ROMs), electronically erasable programmable read-only memory (PROMs), programmable logic devices (PLDs) and programmable logic arrays (PLAs). The computing devices described herein all include a network interface card or network interface chip or chipset and related software that allow for communication over the network 150. The hardware and firmware components of the computing devices may include various specialized units, circuits, software and interfaces for providing the functionality and features described herein. The processes, functionality and features may be embodied in whole or in part in software which operates on a computing device, for example, a media player, and may be in the form of one or more of or a combination of firmware, an application program, an applet (e.g., a Java applet), a browser plug-in, a COM object, a dynamic linked library (DLL), a script, a widget, a subroutine, or an operating system component or service. The hardware and software and their functions may be distributed such that some actions are performed by a computing device and others by other devices coupled with or included in the computing device.

A computing device as used herein includes a processor, memory and a storage device that may execute instructions including, but not limited to, personal computers, server computers, computing tablets, set-top boxes, cable boxes, video game systems, personal video recorders, video players including Blu-ray Disc® players, telephones, personal digital assistants (PDAs), portable computers, and laptop computers. These computing devices may run an operating system, including, for example, variations of the Linux, Unix, MS-DOS, Microsoft Windows, Palm OS, Solaris, Chrome, Symbian, and Apple Mac OS X operating systems.

As used herein, the terms media and storage media include, for example, magnetic media such as hard disks, floppy disks and tape; optical media such as compact discs (CD-ROM and CD-RW), digital versatile discs (DVD and DVD±RW) and Blu-ray Disc® discs (BD-ROM); flash memory cards; storage cartridges that include memory; media cartridges, cards or sticks; and other storage media. As used herein, a storage device is a device that allows for reading and/or writing to a storage medium. Storage devices include hard disk drives, Blu-ray Disc® players, DVD players, personal video recorders, flash memory readers, and others.

The techniques described herein may be implemented by specialized software. The specialized software may be referred to as VDS software. The VDS software may include software that is included on one or more of or a combination of a BD disc or other portable media, software included in a BD player or other media player, and software on a server. VDS client software may be included in the software that executes on a media player. The software that executes on a server is referred to as VDS server software. The VDS client may be obtained from a BD disc or included in a ROM or similar device in a media player. VDS client software includes VDS navigator software. The VDS navigator software included in the BD player executes, creating the execution environment for and mounts a VDS disc image. The VDS disc image is stored on and retrieved from a BD disc. The VDS disc image includes content and applications that exist in the form of a mountable BD-ROM disc image that run in the VDS environment. The VDS disc image includes a combination of applications and data that correspond to the BD-ROM specifications, including a file system that may contain Java applications, fonts, sound files, audio-visual stream files, security certificates, disc metadata files, image files, BD-ROM specific database files, and other types of files. The VDS software may be stored in part in a media player such as player 140, namely in a ROM, FPGA or other PLD or other storage media included in the player 140, or other storage media which may be in a storage device included with or otherwise coupled or attached with the media player. The VDS software may execute using a Java virtual machine on a media player. More specifically, the VDS navigator may be written in a combination of an application programming language such as C or C++, assembler code, a Java Virtual Machine (JVM), and other components, such as a BD presentation engine and/or additional extensions, which themselves may exist as a combination of both compiled software code and Java code. The VDS software also includes player logic that may be stored on the player and may be a hybrid of native code, Linux or other script files, and/or data files.

The BD specification includes a section pertaining to VFS updates. Updates in a BD player are validated against a disc identifier (“ID”). According to the BD specification, certain essential files are only permitted to be included on a disc, and may not be supplied in a VFS update. One such kind of file that may not be supplied in an update is certificates. As is well known to those skilled in the art, certificates or digital certificates are used to authenticate senders, web sites and providers of goods and services. Certificates are issued by trusted third parties.

The VDS disc image may be stored in accordance with the BD file system specification (i.e., System Description Blu-ray Disc Read-Only Format: Part 2. File System Specifications) as a file system image file which may be mounted by the disc player. The system image file may conform to the International Organization for Standardization ISO 13346 standard file system specification more commonly known as Universal Disk Format (UDF) (also known as ECMA-167). The VDS disc image may be stored as a file on a USB storage device coupled with or included in a disc player. Other VDS software such as the VDS player logic, VDS navigator and the VDS client may be resident as firmware or be stored in a protected area of local storage (that is, a hard disk drive, silicon storage device or other non-volatile storage included in a BD player) where it cannot be erased through user storage maintenance actions such as formatting. The VDS software may be stored in an area that may be updated via firmware updates. The VDS disc image may be stored as a single large file; as a collection of smaller files that, when assembled together in proper sequence, form the complete disc image; or as a series of raw data blocks on a separate storage device or partition of a storage device. The size of the disc image that is the VDS software could be very small, for example, 5 to 10 MB if not including motion menu backgrounds, and may be larger is more extensive menu backgrounds are provided.

When accessing the VDS from the disc player, the player loads the virtual disc using a similar playback mechanism it uses for a physical disc. In this context, mechanism refers to a technique and not a physical component. Because the VDS disc image may be loaded from a flash memory, certain buffers and demodulation steps needed when reading from an optical disc are not necessary. Because disc based applications execute from a BD disc, no special software or branches are required for device-resident versus disc-resident software. The BD player creates the same required directories in the Application Data Area (ADA) and Binding Unit Data Area (BUDA) for the VDS virtual disc image as it would for a physical disc placed in the player.

BD discs may be assigned an ID according to system specified rules. VFS updates are bound to or associated with this ID. The BD disc ID may differ per manufacturer, model, distributor, retailer, or a combination of these. In one implementation, as a different set of binding unit manifest and binding unit signature files (BUMF and BUSF files) are needed for each BD disc ID, a VDS client software disc ID may be used as the differentiator to distinguish different versions of the VDS instead of the BD disc ID. This would make update creation easier. The BD disc ID can be used to differentiate device, retailer, etc. without affecting the update manifest files. In this situation, one specific BD disc ID may be assigned for player-resident VDS software images. The BD disc ID of the VDS software may be incremented with versions, etc. The BD disc ID of the VDS software may be a unique alphanumeric string or may be a 16 byte integer value that conforms to the BD specification.

In another implementation, when the VDS software (such as the VDS client, VDS navigator and VDS player logic) is available on a number of different commercial players, a dynamic manifest creation process may be used. Using a dynamic manifest creation process allows the VDS software to access and provide multiple sets of user-selectable content updates. The virtual file system (VFS) update process defined in the BD-ROM specifications uses a Binding Unit Manifest File (BUMF) to define how a file downloaded into the player's local storage, known as the Binding Unit Data Area or BUDA, are mapped into the virtual file system. An example BUMF entry is:

<Asset VPFilename=“BDMV/PLAYLIST/01000.mpls”>

<BUDAFile name=“7fff0001/2/updates/circppl/v1/01000.mpl”/>

</Asset>

In this example, the file “01000.mpl” in the player's local storage is mapped to “/BDMV/PLAYLIST/01000.mpls” in the virtual file system. This file may replace a file originally from the BD-ROM disc.

A limitation of the VFS update process described in the BD specification is that Blu-ray only allows one manifest to be present in a player. Further, the BD specification requires that the manifest be cryptographically signed to authenticate the file and to ensure that the files have not been tampered with. Modifications to the manifest invalidate the signature file known as the Binding Unit Signature File or BUSF.

When a content provider or device maker wants to make available three different sets of user-selectable content updates, A, B and C, for example, multiple BUMF/BUSF pairs must be prepared and provided. For the situation when a user selects content A and C, but not B, then a BUMF/BUSF pair is provided for those two update sets. For the situation when a user chooses to have A and B, but not C, a separate BUMF/BUSF pair is provided for those two update sets. From the three different content sets in this example, there are seven different possible arrangements: [1] A, [2] B, [3] C, [4] AB, [5] BC, [6] AC, and [7] ABC. As the number of available content sets increases, the number of possible arrangements increases in a non-linear fashion, requiring a large number of possible combinations for which BUMF/BUSF file pairs must be made available.

The dynamic manifest creation process in the VDS addresses this problem. In one embodiment of the VDS, a VDS server generates an appropriate manifest (BUMF) and cryptographically signs it (BUSF) based on what content sets it determines a particular player needs. In some implementations, the VDS server itself keeps track of the content sets the player already has and prepares a new BUMF/BUSF pair when additional content sets are added or removed. In other implementations, the VDS client application may indicate to the VDS server the content sets the player currently has and those content sets to be added to or removed from the player. In another implementation, the VDS client generates the BUMF based on information about installed and available content sets. In this embodiment, the VDS client sends the BUMF to the VDS server for signing. In response, the VDS server sends and the VDS client receives a BUSF based on the BUMF.

In all of these implementations, the cryptographic keys used to sign the BUMF are kept secret to avoid abuse of the content sets and, in particular, the proprietary information and/or copyright protected information included in the content sets. As a result, there are security implications in the handling of the signature process. In some implementations, the VDS server may run its own protected signing process or have a secure connection to a separate signing server that may, for example, be behind a firewall. In another implementation, authentication between the VDS client and VDS server is required for the VDS server to confirm that the VDS client is known and that its request is valid. Keeping the client-server exchange secure may be difficult, making it a less desirable implementation in some circumstances.

The provider of the VDS may define, in consultation with each player manufacturer, how the VDS software, the VDS disc image or file system is provided and stored on the player so that when an end user selects the VDS option through the player user interface (UI), the virtual disc image is accessed. In one implementation, Java Archives (“JARs”) and assets, namely content such as, for example, images and data files beyond the application code itself that an application requires to run, may be pre-loaded in the player memory (RAM) on player startup to speed VDS application launch. More specifically, assets may include images that make up the elements of the user interface, data files that describe the user interface and how it should operate, and video sequences or still frames that are played as backdrops for the application. Assets may also include font files, sound files (for use as, for example, sound effects), and other types of files used by the application. The JARs and assets may be stored in a PROM or flash memory included in the player and transferred to RAM in the player on startup. Performance requirements may be specified so that startup time is within a recommended VDS threshold. Typical example startup times include 5, 10, and 20 seconds.

As set forth in the description above, the VDS complies with the BD specification. That is, the software included in layers as VDS utilizes application programming interfaces (APIs) and system components defined by the BD-ROM specification. Extended features outside the BD-ROM specification may also be included with the VDS. Extended features include but are not limited to avoidance of title-unbound application restarts when doing VFS udpates, utilization of additional playback capabilities such as MP3 audio, and support for alternative digital rights management (DRM) systems.

BD players that implement the VDS may switch between applications or other software on the virtual disc and applications or other software installed on real disc media, namely DVDs, BD-ROMs, etc.

Methods

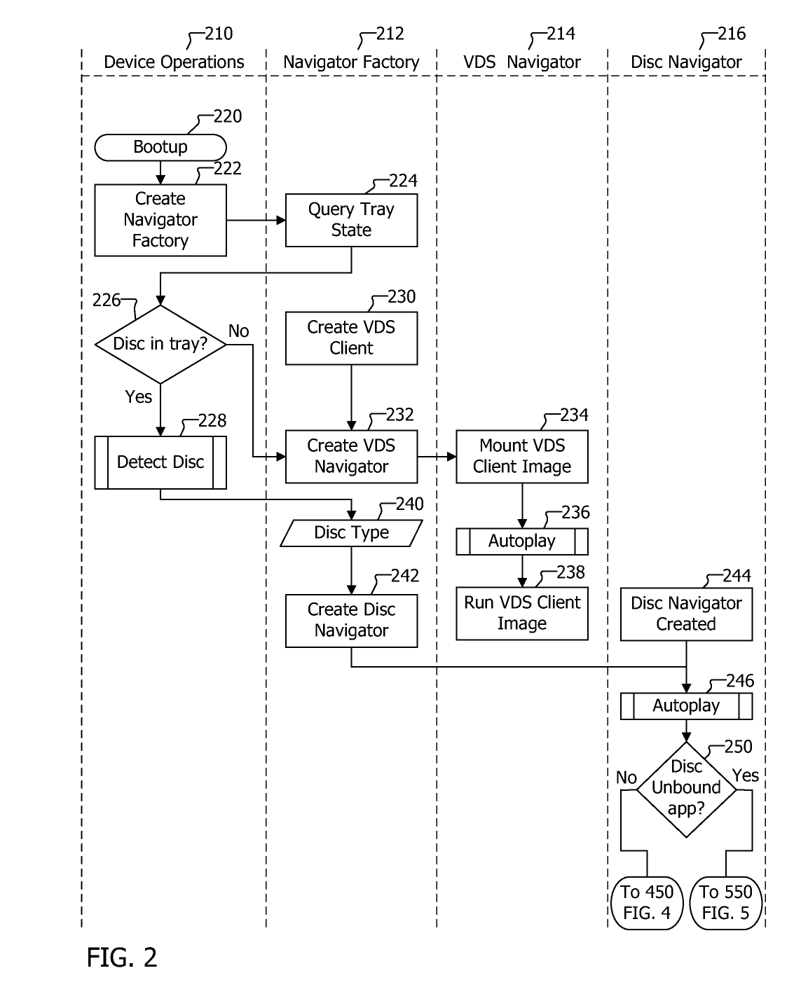

FIGS. 2-5 show actions taken by various software components involved in implementing the VDS in a BD player. Each of these processes or components are implemented in software stored on a ROM, PROM, PLD or other readable storage memory or silicon device included in a media player. Although shown and described as four separate and distinct components, the functionality described can be implemented in a single program or in more or fewer than the four components described. These four components—device operations (or player logic), navigator factory, VDS navigator and disc navigator—are provided as an example implementation of a VDS enhanced player.

The Device Operations (that may be implemented as player logic) shown as 210, 310, 410 and 510 include software, firmware and hardware that implement disc detection and recognition. This component uses technology included in current media players. This process may optionally include a third party disc recognition technology, such as the MusicID® software and system for audio disc recognition, and the VideoID software and system for video disc recognition available from Gracenote of Emeryville, Calif. Disc recognition software and systems identify the title on a disc upon insertion and provide additional information and metadata that other applications can access. The VDS may access and use the title, information and metadata acquired from a disc recognition software and system.

The VDS software may include a Navigator Factory shown as 212, 312, 412 and 512 The navigator factory is a software process that determines what actions are taken based on system events. System events include, for example, a disc being inserted, a disc being removed, keys or buttons on the player being pressed, and others. The navigator factory either initiates execution of a disc navigator or of a VDS navigator depending on whether there is a disc provided in the player. The disc player is used to play the disc while the VDS navigator is used to execute a VDS disc image.

The VDS software may include a VDS Navigator shown as 214, 314, 414 and 514. The VDS navigator refers to the virtual disc execution environment that executes the VDS disc image. The VDS Navigator is a software component that performs a portion of the methods described herein.

The VDS software may include a disc navigator shown as 216, 316, 416 and 516. The disc navigator refers to software and/or firmware the implements the physical disc execution environment included in a BD player.

Referring now to FIG. 2, there is shown a flow diagram of actions taken when a player that includes the VDS described herein starts, such as when a player is powered on and reboots or restarts. When a player is powered on, a physical disc may or may not be present in the player. When a disc is detected in the player, the disc navigator 216 is launched immediately upon disc detection to play the disc. This assumes that auto-play is enabled. Otherwise, when no disc is present, the VDS Navigator 214 is launched, starting the VDS.

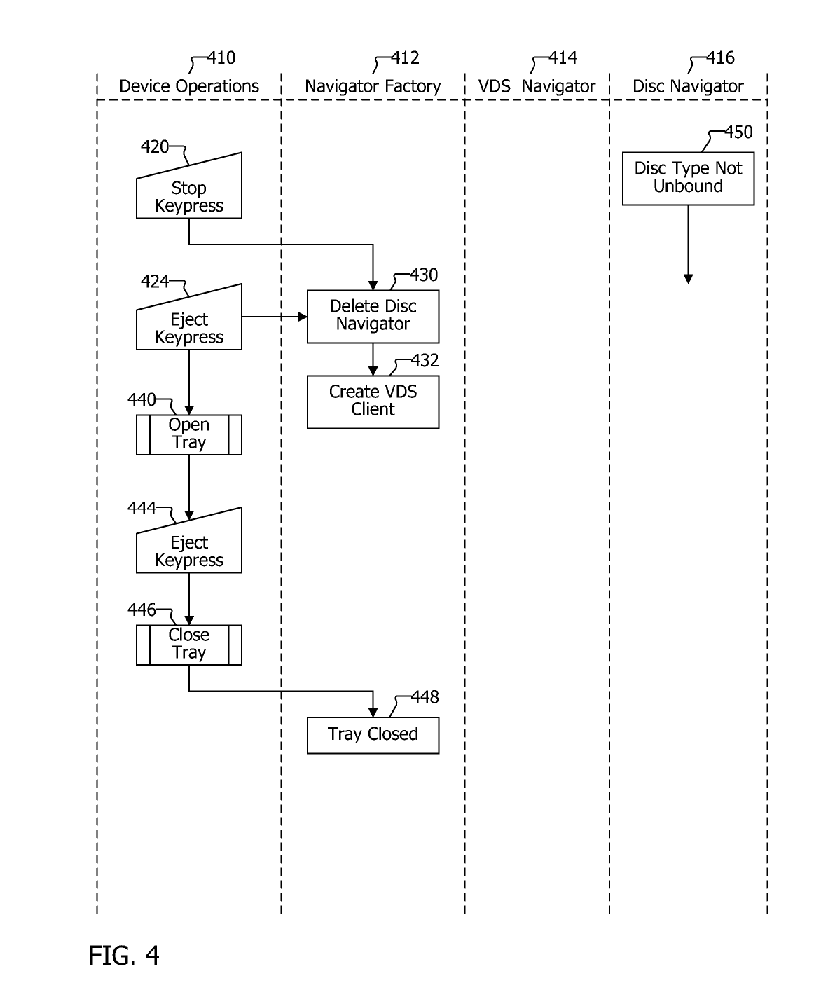

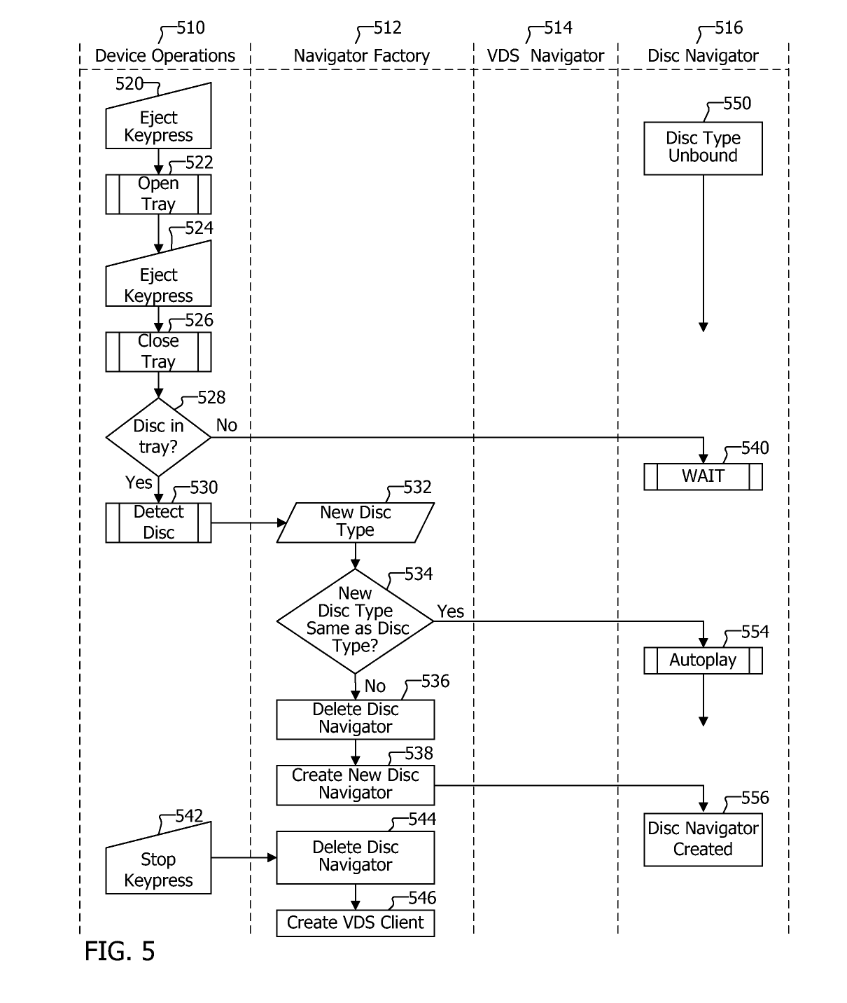

Specifically, when the player boots up (220), software to create the navigator factory (222) is executed. The navigator factory 212 starts and queries the disc tray state (224). A check is made to determine whether there is a disc in the tray (226). When there is a disc in the tray (222), the disc is detected (228) and the navigator factory 212 executes software to create the disc navigator (240 and 242). The disc navigator 216 is created (244), and the disc is automatically played (246). A check is made to determine whether the disc has an unbound application running (250). Actions taken by the disc navigator when there is an unbound application running continue at block 550 of FIG. 5. Actions taken by the disc navigator when there is no unbound application running continue at block 450 of FIG. 4.

However, in a player augmented with the VDS, when there is a no disc in the tray (222), the navigator factory 212 executes software to create the VDS client and VDS navigator (230 and 232), which may be one and the same. The VDS Navigator 214 may be created by mounting and then playing the VDS client image (234, 236 and 238) such that the virtual disc image that is the VDS clients is automatically played (236) to create the VDS Navigator (238). In this way, a virtual disc image is executed in the player when no physical disc is detected in the player's disc tray upon power on or reboot/restart.

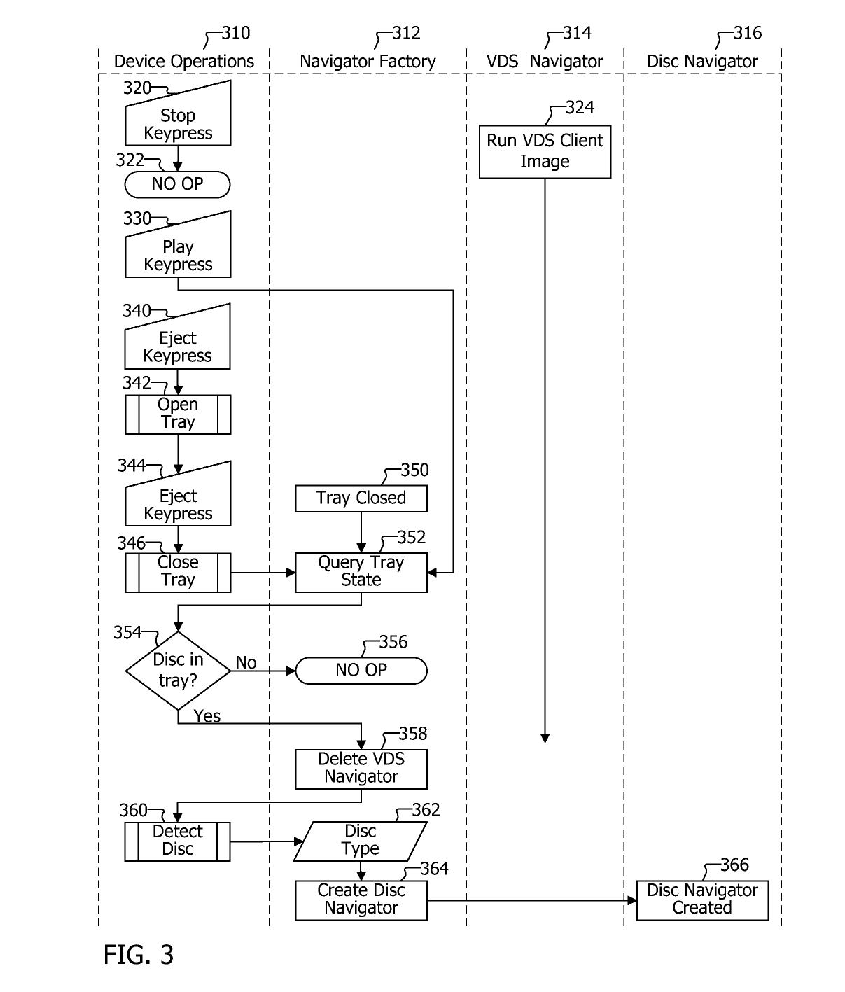

FIG. 3 is a flow diagram of actions taken when a player that includes the virtual disc system described herein is playing or executing the virtual disc system. A VDS client image such as the VDS Navigator 314 is currently playing (324). In this state, the stop button has no effect. When a stop key press (320) is detected on the player, no operations are performed (322). When the play key is pressed (330), the navigator factory (312) issues a query to the player about the state of the disc tray (352). When no disc is present in the tray (354), the play button will have no effect (356). When a disc is present in the tray (354), the execution of the VDS Navigator is stopped. This may be achieved by the navigator factory (312) deleting the VDS Navigator job or process (358). A disc detected state is entered (360), a query is made to determine the disc type (362), and the disc navigator is created (364 and 366).

Also in this state, when the VDS Navigator 314 is currently playing (324), when a new disc is inserted into the tray as detected by the tray door being closed (350) and a disc being detected in the tray (354), the VDS Navigator 314 will be deleted (358), the disc type is detected (360, 362), the disc navigator is created (364), and the disc navigator 316 automatically plays the disc.

FIG. 4 is a first flow diagram of actions taken when a player that includes the virtual disc system described herein plays a physical disc. A physical disc which does not include a disc-unbound application is played by the disc navigator 416 (450). An unbound application in an application continues to run after the disc has been removed from the player and keeps running until either a new disc is inserted that does not recognize the running application or execution is halted by user operation (for example, hitting the STOP key on the player). In this sense, while the application is running, the disc navigator is actively executing the disc-unbound application. Execution continues during disc insertion and detection up until the system determines that either the new disc is not a BD disc, a BD disc that does not recognize the current running application, or the user stops execution via user operation, such as by detection of a stop or eject key press. In the first two cases, a new disc navigator for the new disc is launched to play the new disc. In the final case, the VDS navigator is created and launched. Specifically, when a disc is being played by the disc navigator 416 (450) and a stop key press is detected (420) or an eject key press is detected (424), the navigator factory 412 deletes the disc navigator 416 process or otherwise terminates execution of the disc navigator 416 (430). The navigator factory then creates or starts the VDS navigator 314 (432), and the actions proceed at block 232 of FIG. 2 where the VDS navigator is started or otherwise executed so that the VDS disc image may execute. In addition, when the eject key press is detected, the open tray (440) may be closed by another eject key press (444) that causes the tray to be closed (446); the navigator factory recognizes this (448). The flow of action continues at FIG. 3, block 352.

FIG. 5 is a second flow diagram of actions taken when a player that includes the virtual disc system described herein plays a physical disc. In this example, a physical disc including a disc-unbound application is played by the disc navigator 516 (550). As such, an application provided on the disc continues to run after the disc has been removed from the player. In this state, an eject key press (520) places the player in a wait state (540) while the disc is ejected. That is, the disc navigator remains running and waits to take actions (or takes no or limited actions) until a disc is placed in the device. Specifically, an eject key press is detected (520), causing the tray to open (522). Another eject key press is detected (524) causing the tray to close (526). A check is made to determine if a disc is in the tray (528). If there is no disc in the tray (528), the disc navigator 516 enters a wait state (540). When no disc is present, and the stop button is pressed (542) while in this wait state, the disc navigator 516 will be deleted or otherwise terminated (544), also terminating the unbound application. The VDS Navigator 514 is then created (546), and the flow of actions continues at block 232 of FIG. 2.

When a new disc is inserted while the disc navigator in the wait state (528, 540), the disc detection algorithm evaluates the type of the new disc that was inserted (532). If the disc is of the same type of that which the unbound application is associated (534), the disc navigator 516 becomes active and the disc is automatically played (554). If the disc type is different from the type of that which the unbound application is associated (534), the disc navigator 516 is deleted or otherwise terminated (536), and the navigator factory 512 then creates a disc navigator 516 for the new disc type (538, 556).

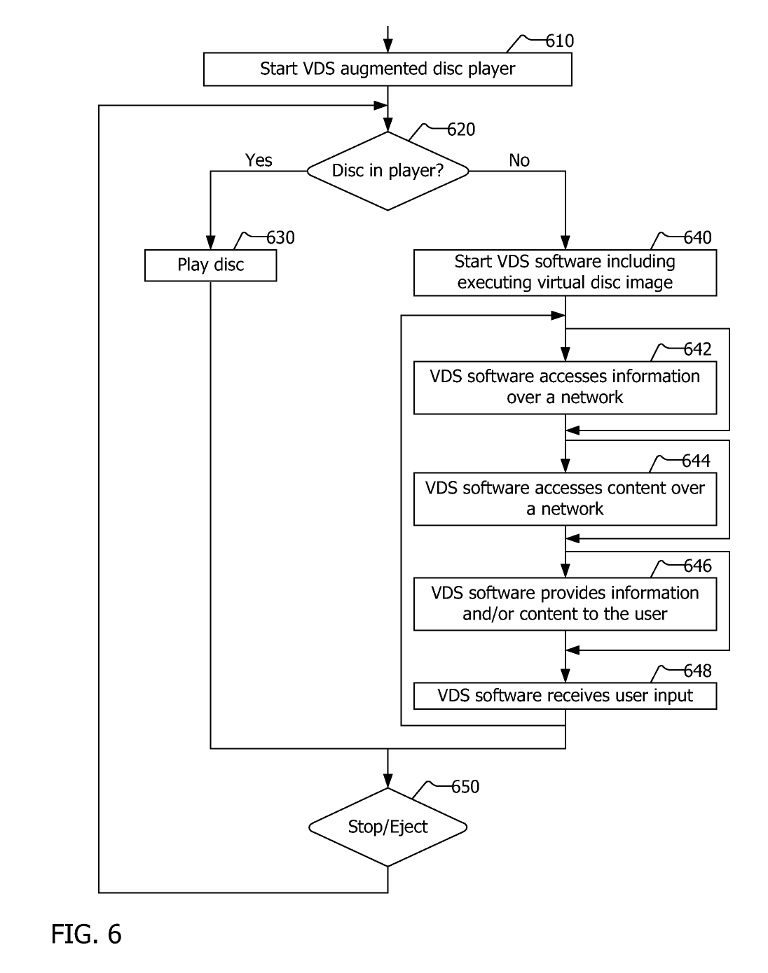

Now that a specific implementation of a VDS has been described, a more general description is provided in FIG. 6. FIG. 6 is a flow diagram of actions taken in a VDS enabled media player. A VDS enabled media player may be a media player that includes VDS software. The VDS software may include the following components or may include the functionality associated with the following components: a VDS client, a VDS navigator, player logic, a navigator factory and/or a disc navigator as described above.

A VDS augmented disc player starts (610). A check is made to determine whether there is a disc in the player (620). When there is a disc in the player, the disc is played by the player as it would typically be played (630). When there is no disc in the player, the VDS software starts execution including executing a virtual disc image (640). Depending on the embodiment, the VDS software may have been pre-installed on the player and stored on an internal hard disk drive, PROM or similar device, or may have been transferred to the player from an earlier played disc and stored in the player on an internal hard disk drive, PROM, or similar device. The VDS software accesses information over a network such as the Internet (642). The VDS software may access content over the network (644). The VDS software provides information and/or content to the user via the player (646). The VDS software may receive user input (648). The information and content accessed may relate to discs already played in the player, may be responsive to or based on user input, or may be provided by the manufacturer or distributor of the player. The information and/or content may be obtained directly from servers such as content and application servers. The information and/or content may be obtained from VDS servers which communicate with other servers such as content and application servers. As shown, some of steps 642-648 may be skipped or repeated according to the particular implementation and/or based on user input and/or based on other requirements such as those that may be provided by a player manufacturer or network provider.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A media player comprising a storage medium having instructions stored thereon which when executed by a processor in the media player cause the media player to perform actions comprising:
detecting whether a portable storage medium is present in the media player
when the portable storage medium is present in the media player,
identifying a type of the portable storage medium
starting a media navigator for the type of media
the media navigator playing the disc
when there is no portable storage medium in the media player,
starting a virtual disc navigator
the virtual disc navigator executing a virtual disc software image including performing at least one of
accessing information over a network
accessing content over the network
providing the information and/or the content to a user through a display coupled with the media player.

2. The media player of claim 1 wherein the virtual disc navigator accessing information and/or content from the server is achieved by communicating with a virtual disc system server that obtains the content and/or information from third party servers.

3. The media player of claim 2 wherein the virtual disc navigator accessing information and/or content is achieved by communicating with one or more servers that provide the content and/or the information.

4. The media player of claim 2 including further instructions stored thereon which when executed by the processor cause the media player to perform further actions comprising:
dynamically creating a manifest of available content sets.

5. The media player of claim 4 wherein dynamically creating a manifest of available content sets includes:
the media player receiving BUMF/BUSF pairs for a user selection of one or more content sets

6. The media player of claim 4 wherein dynamically creating a manifest of available content sets includes:
sending notice to the server specifying at least two from the group including: currently installed content sets, needed content sets, and removed content sets.

7. The media player of claim 4 wherein dynamically creating a manifest of available content sets includes:
generating a BUMF based on player known content set information
sending the BUMF to the server for signing
receiving a BUSF from the server based on the BUMF.

8. The media player of claim 1 including further instructions stored thereon which when executed by the processor cause the media player to perform further actions comprising:
receiving user input including a selection of at least a portion of the content or the information.

9. A disc player conforming to Blu-ray Disc standards, the disc player comprising a storage medium having instructions stored thereon which when executed by a processor in the disc player cause the disc player to perform actions comprising:
detecting whether a disc is present in the disc player
when the disc is present in the disc player,
identifying a type of the disc
starting a disc navigator for the type of disc
the disc navigator playing the disc
when there is no disc in the media player,
starting a virtual disc navigator
the virtual disc navigator executing a virtual disc software image including performing at least one of
accessing information over a network
accessing content over the network
providing the information and/or the content to a user through a display coupled with the disc player
receiving user input.

10. The disc player of claim 9 wherein the virtual disc navigator accessing information and/or content is achieved by communicating with a virtual disc system server that obtains the content and/or information from third party servers.

11. The disc player of claim 10 wherein the virtual disc navigator accessing information and/or content is achieved by communicating with one or more servers that provide the content and/or the information.

12. The disc player of claim 9 including further instructions stored thereon which when executed by the processor cause the disc player to perform further actions comprising:
dynamically creating a manifest of available content sets.

13. The disc player of claim 12 wherein dynamically creating a manifest of available content sets includes:
generating a BUMF based on player known content set information
sending the BUMF to the server for signing
receiving a BUSF from the server based on the BUMF.

14. A disc player conforming to Blu-ray Disc standards, the disc player comprising a storage medium having instructions stored thereon which when executed by a processor in the disc player cause the disc player to perform actions comprising:
detecting whether a disc is present in the disc player
when there is no disc in the disc player,
starting a virtual disc navigator
the virtual disc navigator executing a virtual disc software image including performing at least one of
accessing information over a network
accessing content over the network
providing the information and/or the content to a user through a display coupled with the media player
receiving user input.

15. The disc player of claim 14 wherein the virtual disc navigator accessing information and/or content is achieved by communicating with a virtual disc system server that obtains the content and/or the information from third party servers.

16. The disc player of claim 15 wherein the virtual disc navigator accessing information and/or content is achieved by communicating with one or more servers that provide the content and/or the information.

17. The disc player of claim 15 including further instructions stored thereon which when executed by the processor cause the disc player to perform further actions comprising:
dynamically creating a manifest of available content sets.

18. The disc player of claim 17 wherein dynamically creating a manifest of available content sets includes:
the media player receiving BUMF/BUSF pairs for a user selection of one or more content sets.

19. The disc player of claim 17 wherein dynamically creating a manifest of available content sets includes:
sending notice to the server specifying at least two from the group including: currently installed content sets, needed content sets, and removed content sets.

20. The disc player of claim 17 wherein dynamically creating a manifest of available content sets includes:
generating a BUMF based on player known content set information
sending the BUMF to the server for signing
receiving a BUSF from the server based on the BUMF.
